(19) United States
(12) Patent Application Publication
(10) Pub. No.: US 2015/0126418 A1
(43) Pub. Date: May 7, 2015

(54) HYDRAULIC FLUIDS CONTAINING DIBASIC ESTERS AND METHODS FOR USE

(71) Applicants: David Fluck, Elkton, MD (US); Amit Sehgal, Cherry Hill, NJ (US); Charles Aymes, Monmouth Junction, NJ (US)

(72) Inventors: David Fluck, Elkton, MD (US); Amit Sehgal, Cherry Hill, NJ (US); Charles Aymes, Monmouth Junction, NJ (US)

(73) Assignee: Rhodia Operations, Aubervilliers (FR)

(21) Appl. No.: 13/982,698

(22) PCT Filed: Jan. 30, 2012
(86) PCT No.: PCT/US2012/023101

§ 371 Date: Sep. 18, 2013

Related U.S. Application Data
(60) Provisional application No. 61/462,347, filed on Jan. 31, 2011.

(51) Int. Cl. C09K 8/68

(52) U.S. Cl. CPC C09K 8/68; C09K 2208/34
USPC 507/260

(57) ABSTRACT

A functional fluid composition comprising a mixture of: (a) at least one base fluid component; and (b) an additive component comprising a blend of dibasic esters. The functional fluid can optionally comprise second additive components. The blend of dibasic esters comprises two or more of dialkyl methylglutarate, dialkyl adipate, dialkyl ethylsuccinate, dialkyl succinate, dialkyl glutarate.

### CROSS-REFERENCE TO RELATED APPLICATION

This application claims the benefit of U.S. Provisional Application Ser. No. 61/462,347 filed Jan. 31, 2011, herein incorporated by reference.

### FIELD OF THE INVENTION

This invention relates to hydraulic and lubricating fluids containing dibasic esters and in particular hydraulic fluids containing a blend of linear or branched dibasic esters.

### BACKGROUND OF THE INVENTION

Hydraulic fluids or liquids convery power as its primary function. More specifically, hydraulic fluids transfer power in hydraulic machinery. For example, hydraulic fluids can be designed to transmit motion and force in industrial hydraulic systems. Common hydraulic fluids are based on mineral oil or water. Examples of equipment and systems that might use hydraulic fluids include automobiles, excavators and backhoes, brakes, power steering systems, transmissions, earthmovers, garbage trucks, aircraft flight control systems, elevators, and industrial machinery.

In use, there are other important functions of hydraulic fluid such as protection of the hydraulic machine components, as secondary functions. For example, industrial non-mobile hydraulic systems and mobile vehicles are equipped with some type of transmission (i.e., semi-automatic or fully automatic), which must be supplied with a fluid that serves multiple functions such as not only a power transmitting medium, but also as a hydraulic control fluid, a heat transfer medium, etc. Some important functions of a hydraulic fluid (other than as a medium for power transfer and control) include: as a medium for heat transfer, as a sealing medium, as a lubricant, to increase pump efficiency, to increase fire resistance, to increase radiation resistance, as a fluid (life) extender, etc.

### SUMMARY OF THE INVENTION

This present invention comprises hydraulic fluids containing one or more branched or linear dibasic esters, wherein the hydraulic fluid has improved properties including but not limited to lubricity and relatively improved environmental profile. The dibasic esters utilized described herein present an improved Health, Safety, and Environmental (HSE) profile. They are readily biodegradable, non-flammable (with high flash points), non-toxic, non-irritant and non-sensitizers. They also have a very low vapor pressure (non-VOC per CARB 310 and EU 1999/13/EC), and high boiling points while maintaining low viscosities.

The present invention will become apparent from the following detailed description and examples, which comprises in one aspect, is a functional fluid composition comprising a mixture of: (a) at least one base fluid component; and (b) an additive component comprising a blend of dibasic esters. In one embodiment, the base fluid component a hydraulic fluid base component. The functional fluid composition can further comprising a second additive component.

The dibasic esters can be derived from adipic, glutaric, and succinic diacids, or isomers thereof. In one particular embodiment, the dibasic ester blend is comprised of a mixture dialkyl methylglutarate, dialkyl ethylsuccinate and, optionally, dialkyl adipate, where the alkyl groups individually comprise C₁-C₁₂ hydrocarbon groups. In another particular embodiment, the dibasic ester blend is comprised of a mixture dialkyl glutarate, dialkyl succinate and dialkyl adipate, where the alkyl groups individually comprise C₁-C₁₂ hydrocarbon groups.

In one embodiment, the blend of dibasic esters comprises (i) a dialkyl methylglutarate and (ii) a dialkyl ethylsuccinate. In another embodiment, blend of dibasic esters comprises dialkyl adipate, dialkyl methylglutarate and dialkyl ethylsuccinate.

In one embodiment, the blend of dibasic esters comprises:

(i) from about 5-25%, by weight of the blend, a first dibasic ester of formula:

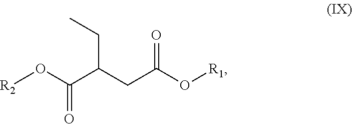

(ii) from about 70-95%, by weight of the blend, a second dibasic ester of formula:

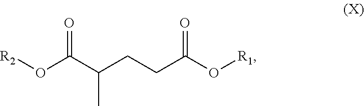

and

(iii) optionally, from about 0-5%, by weight of the blend, a third dibasic ester of formula:

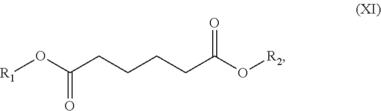

wherein R₁ and R₂ are hydrocarbon groups individually selected from C₁-C₁₃ alkyl, C₁-C₁₃ aryl, C₁-C₁₃ alkaryl, C₁-C₁₃ alkoxy, C₁-C₁₃ alkylarylalkyl, C₁-C₁₃ arylalkyl, C₁-C₁₃ alkylamidoalkyl or C₁-C₁₃ alkylaminoalkyl. In another embodiment, R₁ and R₂ are hydrocarbon groups individually selected from methyl, ethyl, propyl, isopropyl, n-butyl, pentyl, isoamyl, hexyl, heptyl or octyl. In one embodiment, the blend of dibasic esters is characterized by vapor pressure of less than about 10 Pa.

In one embodiment, the blend of dibasic esters comprises:

(i) from about 20-28%, by weight of the blend, a first dibasic ester of formula:

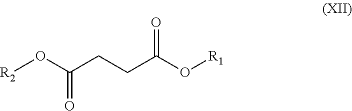

(ii) from about 59-67%, by weight of the blend, a second dibasic ester of formula:

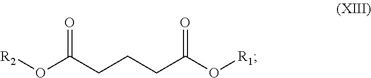

and

(iii) from about 9-17%, by weight of the blend, a third dibasic ester of formula:

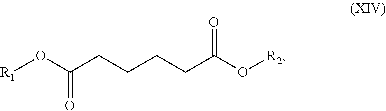

wherein R₁ and R₂ are hydrocarbon groups individually selected from C₁-C₁₃ alkyl, C₁-C₁₃ aryl, C₁-C₁₃ alkaryl, C₁-C₁₃ alkoxy, C₁-C₁₃ alkylarylalkyl, C₁-C₁₃ arylalkyl, C₁-C₁₃ alkylamidoalkyl or C₁-C₁₃ alkylaminoalkyl. In one embodiment, R₁ and R₂ are hydrocarbon groups individually selected from methyl, ethyl, propyl, isopropyl, n-butyl, pentyl, isoamyl, hexyl, heptyl or octyl. In another embodiment, R₁ and R₂ are individually selected from branched, linear and/or cyclic C₁-C₁₀ hydrocarbon groups.

In one embodiment, the additive component is less than about 50% by weight of the functional fluid composition.

In another aspect, described herein are methods of increasing lubricity or other properties of a functional fluid, such as a hydraulic fluid, by contacting an effective amount of one or more blend of dibasic esters with the functional fluid.

The dibasic esters described herein are environmentally friendly (including but not limited to being non toxic, bio-degradable, non-flammable and the like), with a high flash point, low vapor pressure and low odor; falls under the consumer products LVP-VOC exemption criteria established by CARB and the EPA (CARB 310 and EU 1999/13/EC).

### BRIEF DESCRIPTION OF FIGURES

FIG. 1 shows the lubricity of a blend of dibasic esters as described herein in hexane;

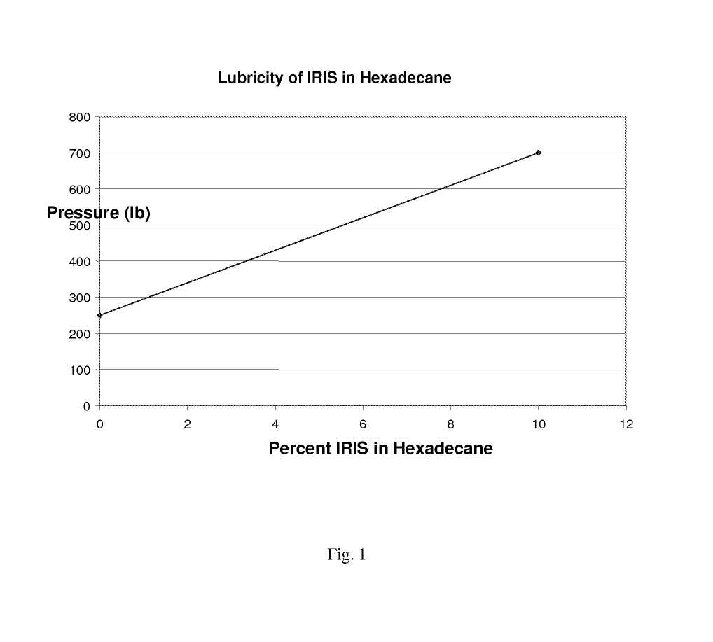

FIG. 2 shows distillation range of branched and linear blends of dibasic esters; and

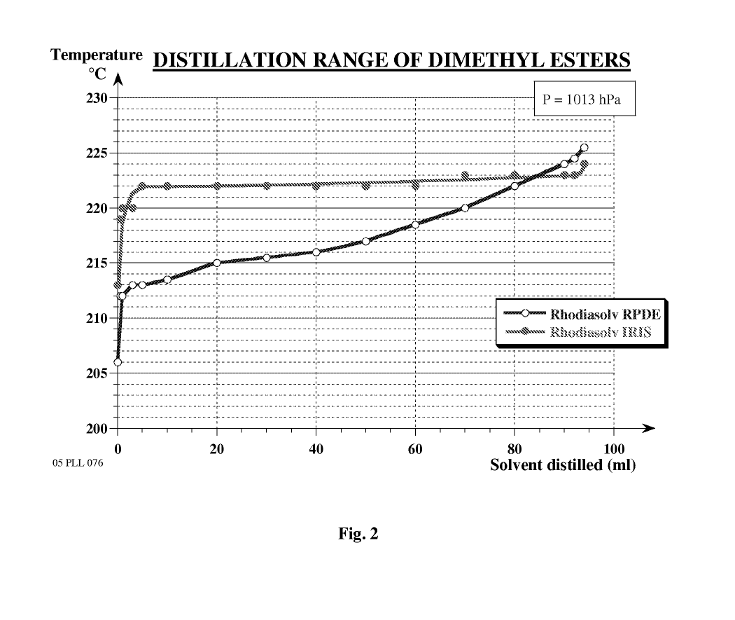

FIG. 3 shows freezing point ranges of branched and linear blends of dibasic esters.

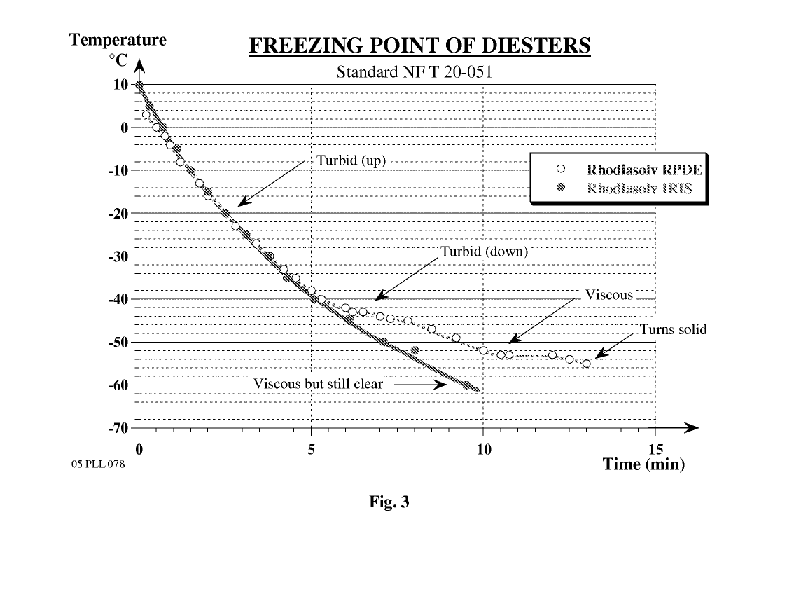

### DETAILED DESCRIPTION

As used herein, the term “alkyl” means a saturated straight chain, branched chain, or cyclic hydrocarbon radical, including but not limited to, methyl, ethyl, n-propyl, iso-propyl, n-butyl, sec-butyl, t-butyl, pentyl, n-hexyl, and cyclohexyl.

As used herein, the term “aryl” means a monovalent unsaturated hydrocarbon radical containing one or more six-membered carbon rings in which the unsaturation may be represented by three conjugated double bonds, which may be substituted one or more of carbons of the ring with hydroxy, alkyl, alkenyl, halo, haloalkyl, or amino, including but not limited to, phenoxy, phenyl, methylphenyl, dimethylphenyl, trimethylphenyl, chlorophenyl, trichloromethylphenyl, aminophenyl, and tristyrylphenyl.

As used herein, the term “alkylene” means a divalent saturated straight or branched chain hydrocarbon radical, such as for example, methylene, dimethylene, trimethylene.

As used herein, the terminology “(Cᵣ-Cₛ)” in reference to an organic group, wherein r and s are each integers, indicates that the group may contain from r carbon atoms to s carbon atoms per group.

Described herein are functional fluid compositions comprising a mixture of: (a) at least one base fluid component; and (b) an additive component comprising a blend of dibasic esters. The base fluid component are typically hydraulic fluids. These fluids usually have to operate under extreme temperature ranges. Dibasic esters can function as a lubricant and/or a carrier fluid in these kinds of systems and temperature ranges. In one embodiment, the branched dibasic esters described herein and used as an additive component in functional fluids, have higher and sharper boiling range with a lower freezing point, relative to linear dibasic esters. This makes these dibasic esters better candidates as carriers or fluids in these kinds of systems. In addition IRIS-based dibasic esters (as described herein) have shown to enhance lubricity in non-polar fluids.

The dibasic esters, including when utilized as an additive component, described herein have desirable qualities including one or a combination of: being substantially non-toxic, being non-flammable, being readily biodegradable, having a high flash point, having low vapor pressure, having low odor, and meeting the consumer products LVP-VOC exemption criteria established by CARB and the EPA, such as CARB 310 and the EU 1999/13/EC.

The functional fluids described herein can have a variety of applications; for example, functional fluids can be utilized as hydraulic fluids, grease, metalworking fluids, as lubricating oils, and as heat-transfer fluids. Typically, the functional fluid has an application as primarily a hydraulic fluid.

Hydraulic fluid used herein are compositions useful in any system wherein a mechanical effort is converted to generate pressure or force at a first location, then the pressure or force is converted to a second mechanical effort at the second location. The hydraulic systems contemplated include but are not limited to hydraulic jacks, hydraulic brake systems, hydraulic steering mechanisms, hydraulic transmissions, hydraulic lifts, systems used in heavy equipment, transportation vehicles, highway and construction equipment, railways, airplanes, aerospace and aquatic vehicles.

The functional fluids described herein typically have two components. The first component is a base fluid. The base fluid component may be a synthetic component, a petroleum-derived component, or a biologically-derived component. In one embodiment, the base fluid is one or a combination of two or more of the synthetic component, the petroleum-derived component, and/or the biologically-derived component. Petroleum-derived base fluids are sometimes referred to as mineral oils, and is often used in developing functional fluids. Synthetic base fluids are usually products of petroleum-derived organic chemicals, and can be used for extreme applications where petroleum-derived base fluids fail or are ineffective. The biologically-derived component can include vegetable oils and animal fats, which are sometimes utilized to formulate environmentally compatible functional fluids.

Besides the base fluid component, functional fluids can also contain an additive component. The additive component serve a purpose by improving or enhancing one or more of the properties already present in the base fluid component, or by adding new properties to the base fluid component. Additive components added to the base fluid component include but are not limited to demulsifiers, dispersants, pour point depressants, thermal stabilizers, anti-leak agents, detergents, agents to improve shelf stability, lubricity agents, extreme pressure agents, agents to improve low temperature performance, friction modifiers, anti-wear agents, oxidation inhibitors, environmental profile, rust inhibiting agents, corrosion inhibitors, emulsifiers, anti-foam agents, and rheology and viscosity modifiers. In one embodiment, the additive component is not limited to enhancing, improving or imparting just one of the properties as listed above. Rather, the additive component can impart at least one of the properties; for example, can enhance the environmental profile of the functional fluid while acting as a lubricity agent and corrosion inhibitor. As another non-limiting example, the additive component can act as a lubricity agent, as an anti-wear agent, as a viscosity modifier and as an oxidation inhibitor.

In some embodiment, the additive component is added to the base fluid component along with other additives. The other additives can include those listed above such as dispersants, detergents, antioxidant agents, rheology and viscosity modifiers, and the like. Typically, other additives added to the base fluid component depend of the nature of the end use of the functional fluid.

For example, in one embodiment, for functional fluids having an automatic transmission fluid end use, the additives typically present include dispersant agents, detergent agents, antioxidant agents, anti-wear agents, viscosity modifiers, friction modifiers, pour point depressants, foam inhibitors, as well as corrosion inhibitors. In one embodiment, for functional fluids having a hydraulic fluid end use, the additives typically present include detergent agents, antioxidant agents, anti-wear agents, viscosity modifiers, friction modifiers, pour point depressants, foam inhibitors, as well as corrosion inhibitors. As another example, functional fluids having an industrial hydraulic fluid end use, contain the additives under hydraulic fluids but are absent of a friction modifier. As yet another example, functional fluids having an end use as a grease would typically contain a thickener and additives such as an anti-wear agent, an antioxidant, and a corrosion inhibitor. The amount of each additive would be different in the various functional fluid end-use applications.

In one embodiment, the additive component is less than about 50% by weight of the functional fluid composition. In another embodiment, the additive component is less than about 25% by weight of the functional fluid composition. In yet another embodiment, the additive component is less than about 15% by weight of the functional fluid composition. In a further embodiment, the additive component is less than about 10% by weight of the functional fluid composition. In another embodiment, the additive component is less than about 5% by weight of the functional fluid composition. Typically, the additive component comprises a blend of dibasic esters.

In one embodiment, the blend comprises adducts of alcohol and linear diacids, the adducts having the formula R₁—OOC-A-COO—R₂ wherein R₁ and/or R₂ comprise, individually, a C₁-C₁₂ alkyl, more typically a C₁-C₈ alkyl, and A comprises a mixture of —(CH₂)₄—, —(CH₂)₃, and —(CH₂)₂—. In another embodiment, R₁ and/or R₂ comprise, individually, a C₄-C₁₂ alkyl, more typically a C₄-C₈ alkyl. In one embodiment, R₁ and R₂ can individually comprise a hydrocarbon group originating from fusel oil. In one embodiment, R₁ and R₂ individually can comprise a hydrocarbon group having 1 to 8 carbon atoms. In one embodiment, R₁ and R₂ individually can comprise a hydrocarbon group having 5 to 8 carbon atoms.

In one embodiment, the blend comprises adducts of alcohol and branched or linear diacids, the adducts having the formula R1-OOC-A-COO—R2 wherein R1 and/or R2 comprise, individually, a C1-C12 alkyl, more typically a C1-C8 alkyl, and A comprises a mixture of —(CH2)4-, —CH2CH2CH(CH3)-, and —CH2CH(C2H5)-. In another embodiment, R1 and/or R2 comprise, individually, a C4-C12 alkyl, more typically a C4-C8 alkyl. It is understood that the acid portion may be derived from such dibasic acids such as adipic, succinic, glutaric, oxalic, malonic, pimelic, suberic and azelaic acids, as well as mixtures thereof.

One or more dibasic esters described herein can be prepared by any appropriate process. For example, a process for preparing the adduct of adipic acid and of fusel oil is, for example, described in the document “The Use of Egyptian Fusel Oil for the Preparation of Some Plasticizers Compatible with Polyvinyl Chloride”, Chuiba et al., Indian Journal of Technology, Vol. 23, August 1985, pp. 309-311.

The dibasic esters described herein can be obtained by a process comprising an “esterification” stage by reaction of a diacid of formula HOOC-A-COOH or of a diester of formula MeOOC-A-COOMe with a branched alcohol or a mixture of alcohols. The reactions can be appropriately catalyzed. Use is preferably made of at least 2 molar equivalents of alcohols per diacid or diester. The reactions can, if appropriate, be promoted by extraction of the reaction by-products and followed by stages of filtration and/or of purification, for example by distillation.

The diacids in the form of mixtures can in particular be obtained from a mixture of dinitrile compounds in particular produced and recovered in the process for the manufacture of adiponitrile by double hydrocyanation of butadiene. This process, used on a large scale industrially to produce the greater majority of the adiponitrile consumed worldwide, is described in numerous patents and works. The reaction for the hydrocyanation of butadiene results predominantly in the formulation of linear dinitriles but also in formation of branched dinitriles, the two main ones of which are methylglutaronitrile and ethylsuccinonitrile. The branched dinitrile compounds are separated by distillation and recovered, for example, as top fraction in a distillation column, in the stages for separation and purification of the adiponitrile. The branched dinitriles can subsequently be converted to diacids or diesters (either to light diesters, for a subsequent transesterification reaction with the alcohol or the mixture of alcohols or the fusel oil, or directly to diesters in accordance with the invention). For example, the blend of dibasic esters is derived or taken from the methylglutaronitrile product stream in the manufacture of adiponitrile.

Dibasic esters described herein can be derived from one or more by-products in the production of polyamide, for example, polyamide 6,6. In one embodiment, the cleaning composition comprises a blend of linear or branched, cyclic or noncyclic, C₁-C₂₀ alkyl, aryl, alkylaryl or arylalkyl esters of adipic diacids, glutaric diacids, and succinic diacids. In another embodiment, the cleaning composition comprises a blend of linear or branched, cyclic or noncyclic, C₁-C₂₀ alkyl, aryl, alkylaryl or arylalkyl esters of adipic diacids, methylglutaric diacids, and ethylsuccinic diacids

Generally, polyamide is a copolymer prepared by a condensation reaction formed by reacting a diamine and a dicarboxylic acid. Specifically, polyamide 6,6 is a copolymer prepared by a condensation reaction formed by reacting a diamine, typically hexamethylenediamine, with a dicarboxylic acid, typically adipic acid.

In one embodiment, the blend of the present invention can be derived from one or more by-products in the reaction, synthesis and/or production of adipic acid utilized in the production of polyamide, the cleaning composition comprising a blend of dialkyl esters of adipic diacids, glutaric diacids, and succinic diacids (herein referred to sometimes as “AGS” or the “AGS blend”). In one embodiment, the blend of esters is derived from by-products in the reaction, synthesis and/or production of hexamethylenediamine utilized in the production of polyamide, typically polyamide 6,6.). In one embodiment, the blend of dibasic esters is derived or taken from the methylglutaronitrile product stream in the manufacture of adiponitrile; the cleaning composition comprises a blend of dialkyl esters of methylglutaric diacids, ethylsuccinic diacids and, optionally, adipic diacids (herein referred to sometimes as “MGA”, “MGN”, “MGN blend” or “MGA blend”).

The boiling point of the dibasic ester blend of the present invention is between the range of about 120° C. to 450° C. In one embodiment, the boiling point of the blend of the present invention is in the range of about 160° C. to 400° C.; in one embodiment, the range is about 210° C. to 290° C.; in another embodiment, the range is about 210° C. to 245° C.; in another embodiment, the range is the range is about 215° C. to 225° C. In one embodiment, the boiling point range of the blend of the present invention is between about 210° C. to 390° C., more typically in the range of about 280° C. to 390° C., more typically in the range of 295° C. to 390° C. In one embodiment, boiling point of the blend of the present invention is in the range of about 215° C. to 400° C., typically in the range of about 220° C. to 350° C.

In one embodiment, the blend of dibasic esters has a boiling point range of between about 300° C. and 330° C. Typically, the diisoamyl AGS blend is associated with this boiling point range. In another embodiment, the dibasic ester blend of the present invention has a boiling point range of between about 295° C. and 310° C. Typically, the di-n-butyl AGS blend is associated with this boiling point range. Generally, a higher boiling point, typically, above 215° C., or high boiling point range corresponds to lower VOC.

According to one embodiment of the present invention, the blend of dibasic esters corresponds to one or more by-products of the preparation of adipic acid, which is one of the main monomers in polyamides. For example, the dialkyl esters are obtained by esterification of one by-product, which generally contains, on a weight basis, from 15 to 33% succinic acid, from 50 to 75% glutaric acid and from 5 to 30% adipic acid. As another example, the dialkyl esters are obtained by esterification of a second by-product, which generally contains, on a weight basis, from 30 to 95% methyl glutaric acid, from 5 to 20% ethyl succinic acid and from 1 to 10% adipic acid. It is understood that the acid portion may be derived from such dibasic acids such as, adipic, succinic, glutaric, oxalic, malonic, pimelic, suberic and azelaic acids, as well as mixtures thereof.

In some embodiments, the dibasic ester blend comprises adducts of alcohol and linear diacids, the adducts having the formula R—OOC-A-COO—R wherein R is ethyl and A is a mixture of —(CH₂)₄—, —(CH₂)₃, and —(CH₂)₂—. In other embodiments, the blend comprises adducts of alcohol, typically ethanol, and linear diacids, the adducts having the formula R¹—OOC-A-COO—R², wherein at least part of R¹ and/or R² are residues of at least one linear alcohol having 4 carbon atoms, and/or at least one linear or branched alcohol having at least 5 carbon atoms, and wherein A is a divalent linear hydrocarbon. In some embodiments A is one or a mixture of —(CH₂)₄—, —(CH₂)₃, and —(CH₂)₂—.

In another embodiment, the R¹ and/or R² groups can be linear or branched, cyclic or noncyclic, C₁-C₂₀ alkyl, aryl, alkylaryl or arylalkyl groups. Typically, the R¹ and/or R² groups can be C₁-C₈ groups, for example groups chosen from the methyl, ethyl, n-propyl, isopropyl, n-butyl, n-amyl, n-hexyl, cyclohexyl, 2-ethylhexyl and isooctyl groups and their mixtures. For example, R¹ and/or R² can both or individually be ethyl groups, R¹ and/or R² can both or individually be n-propyl groups, R¹ and/or R² can both or individually be isopropyl groups, R¹ and/or R² can both or individually be n-butyl groups, R¹ and/or R² can both or individually be iso-amyl groups, R¹ and/or R² can both or individually be n-amyl groups, or R¹ and/or R² can be mixtures thereof (e.g., when comprising a blend of dibasic esters).

In further embodiments the invention can include blends comprising adducts of branched diacids, the adducts having the formula R³—OOC-A-COO—R⁴ wherein R³ and R⁴ are the same or different alkyl groups and A is a branched or linear hydrocarbon. Typically, A comprises an isomer of a C₄ hydrocarbon. Examples include those where R³ and/or R⁴ can be linear or branched, cyclic or noncyclic, C₁-C₂₀ alkyl, aryl, alkylaryl or arylalkyl groups. Typically, R³ and R⁴ are independently selected from the group consisting of methyl, ethyl, propyl, isopropyl, butyl, n-butyl, iso-butyl, iso-amyl, and fusel.

In yet another embodiment, the invention comprises a composition based on dicarboxylic acid diester(s) of formula R⁵—OOC-A-COO—R⁶ wherein group A represents a divalent alkylene group typically in the range of, on average, from 2.5 to 10 carbon atoms. R⁵ and R⁶ groups, which can be identical or different, represent a linear or branched, cyclic or noncyclic, C₁-C₂₀ alkyl, aryl, alkylaryl or an arylalkyl group.

The blend can correspond to a complex reaction product, where mixtures of reactants are used. For example, the reaction of a mixture of HOOC-A^{a}-COOH and HOOC-A^{b}-COOH with an alcohol R^{a}—OH can give a mixture of the products R^{a}OOC-A^{a}-COOR^{a} and R^{a}OOC-A^{b}-COOR^{a}. Likewise, the reaction of HOOC-A^{a}-COOH with a mixture of alcohols R^{a}—OH and R^{b}—OH can give a mixture of the products R^{a}OOC-A^{a}-COOR^{a} and R^{b}OOC-A^{a}-COOR^{b}, R^{a}OOC-A^{a}-COOR^{b} and R^{b}OOC-A^{a}-COOR^{a} (different from R^{a}OOC-A^{a}-COOR^{b} if A^{a} is not symmetrical). Likewise, the reaction of a mixture of HOOC-A^{a}-COOH and HOOC-A^{b}-COOH with a mixture of alcohols R^{a}—OH and R^{b}—OH can give a mixture of the products R^{a}OOC-A^{a}-COOR^{a} and R^{b}OOC-A^{a}-COOR^{b}, R^{a}OOC-A^{a}-COOR^{b}, R^{b}OOC-A^{a}-COOR^{a} (different from R^{a}OOC-A^{a}-COOR^{b} if A^{a} is not symmetrical), R^{a}OOC-A^{b}-COOR^{a} and R^{b}OOC-A^{b}-COOR^{b}, R^{a}OOC-A^{b}-COOR^{b} and R^{b}OOC-A^{b}-COOR^{a} (different from R^{a}OOC-A^{b}-COOR^{b} if A^{b} is not symmetrical).

The groups R¹ and R², can correspond to alcohols R¹—OH and R²—OH (respectively). These groups can be likened to the alcohols. The group(s) A, can correspond to one or more dicarboxylic acid(s) HOOC-A-COOH. The group(s) A can be likened to the corresponding diacid(s) (the diacid comprises 2 more carbon atoms than the group A).

In one embodiment, group A is a divalent alkylene group comprising, on average, more than 2 carbon atoms. It can be a single group, with an integral number of carbon atoms of greater than or equal to 3, for example equal to 3 or 4. Such a single group can correspond to the use of a single acid. Typically, however, it corresponds to a mixture of groups corresponding to a mixture of compounds, at least one of which exhibits at least 3 carbon atoms. It is understood that the mixtures of groups A can correspond to mixtures of different isomeric groups comprising an identical number of carbon atoms and/or of different groups comprising different numbers of carbon atoms. The group A can comprise linear and/or branched groups.

According to one embodiment, at least a portion of the groups A corresponds to a group of formula —(CH₂)ₙ— where n is a mean number greater than or equal to 3. At least a portion of the groups A can be groups of formula —(CH₂)₄— (the corresponding acid is adipic acid). For example, A can be a group of formula —(CH₂)₄—, and/or a group of formula —(CH₂)₃—.

In one embodiment, the composition comprises compounds of formula R—OOC-A-COO—R where A is a group of formula —(CH₂)₄—, compounds of formula R—OOC-A-COO—R where A is a group of formula —(CH₂)₃—, and compounds of formula R—OOC-A-COO—R where A is a group of formula —(CH₂)₂—.

In certain embodiments, the dibasic ester blend comprises:

a diester of formula I:

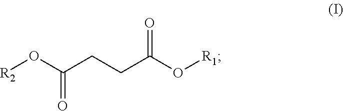

a diester of formula II:

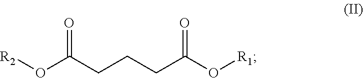

and

a diester of formula III:

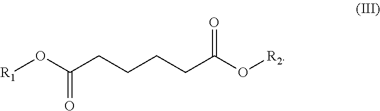

R₁ and/or R₂ can individually comprise a hydrocarbon having from about 1 to about 8 carbon atoms, typically, methyl, ethyl, propyl, isopropyl, butyl, isobutyl, n-butyl, isoamyl, hexyl, heptyl or octyl. In such embodiments, the blend typically comprises (by weight of the blend) (i) about 15% to about 35% of the diester of formula I, (ii) about 55% to about 70% of the diester of formula II, and (iii) about 7% to about 20% of the diester of formula III, and more typically, (i) about 20% to about 28% of the diester of formula I, (ii) about 59% to about 67% of the diester of formula II, and (iii) about 9% to about 17% of the diester of formula III. The blend is generally characterized by a flash point of 98° C., a vapor pressure at 20° C. of less than about 10 Pa, and a distillation temperature range of about 200-300° C. Mention may also be made of Rhodiasolv® RPDE (Rhodia Inc., Cranbury, N.J.), Rhodiasolv® DIB (Rhodia Inc., Cranbury, N.J.) and Rhodiasolv® DEE (Rhodia Inc., Cranbury, N.J.).

In certain other embodiments, the dibasic ester blend comprises:

a diester of the formula IV:

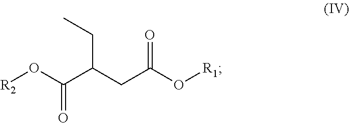

a diester of the formula V:

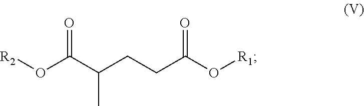

and

optionally, a diester of the formula VI:

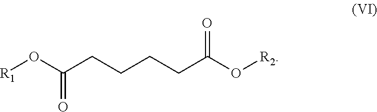

R₁ and/or R₂ can individually comprise a hydrocarbon having from about 1 to about 13 carbon atoms, typically, methyl, ethyl, propyl, isopropyl, butyl, isobutyl, n-butyl, isoamyl, hexyl, heptyl, or octyl. In such embodiments, the blend typically comprises (by weight of the blend) (i) from about 5% to about 30% of the diester of formula IV, (ii) from about 70% to about 95% of the diester of formula V, and (iii) from about 0% to about 10% of the diester of formula VI. More typically, the blend typically comprises (by weight of the blend): (i) from about 6% to about 12% of the diester of formula IV, (ii) from about 86% to about 92% of the diester of formula V, and (iii) from about 0.5% to about 4% of the diester of formula VI.

Most typically, the blend comprises (by weight of the blend): (i) about 9% of the diester of formula IV, (ii) about 89% of the diester of formula V, and (iii) about 1% of the diester of formula VI. The blend is generally characterized by a flash point of 98° C., a vapor pressure at 20° C. of less than about 10 Pa, and a distillation temperature range of about 200-275° C. Mention may be made of Rhodiasolv® IRIS and Rhodiasolv® DEE/M, manufactured by Rhodia Inc. (manufactured by Rhodia Inc., Cranbury, N.J.)

In yet another embodiment, the dibasic ester blend can be any combination of formula (I), formula (II), formula (III), formula (IV), formula (V) and/or formula (VI).

The present invention, therefore, is well adapted to carry out the objects and attain the ends and advantages mentioned, as well as others inherent therein. While the invention has been depicted and described and is defined by reference to particular preferred embodiments of the invention, such references do not imply a limitation on the invention, and no such limitation is to be inferred. Consequently, the invention is intended to be limited only by the spirit and scope of the appended claims, giving full cognizance to equivalents in all respects.

1. A functional fluid composition comprising a mixture of: (a) at least one base fluid component; and (b) an additive component comprising a blend of dibasic esters.

2. The functional fluid composition of claim 1 wherein the at least one base fluid component is at least one hydraulic fluid base component.

3. The functional fluid composition of claim 1 further comprising a second additive component.

4. The functional fluid composition of claim 2 wherein the blend of dibasic esters is selected from the group consisting of dialkyl methylglutarate, dialkyl adipate, dialkyl ethylsuccinate, dialkyl succinate, dialkyl glutarate and any combination thereof.

5. The functional fluid composition of claim 2 wherein the blend of dibasic esters comprises (i) dialkyl methylglutarate and (ii) at least one of dialkyl adipate or dialkyl ethylsuccinate.

6. The functional fluid composition of claim 2 wherein the blend of dibasic esters comprises (i) dialkyl methylglutarate and (ii) dialkyl ethylsuccinate.

7. The functional fluid composition of claim 2 wherein the blend of dibasic esters is derived from one or more by-products in the production of polyamide.

8. The functional fluid composition of claim 2 wherein the blend of dibasic esters is derived from the process to produce adiponitrile.

9. The functional fluid composition of claim 2 wherein the blend of dibasic esters comprises:
(i) from about 5-25%, by weight of the blend, a first dibasic ester of formula: 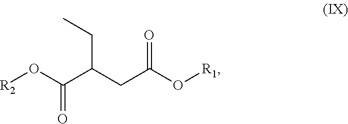
(ii) from about 70-95%, by weight of the blend, a second dibasic ester of formula: 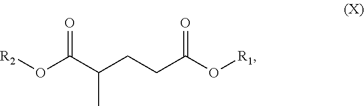
and
(iii) optionally, from about 0-5%, by weight of the blend, a third dibasic ester of formula: 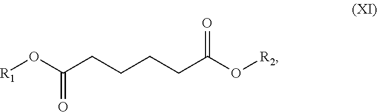
wherein R₁ and R₂ are hydrocarbon groups individually selected from C₁-C₁₃ alkyl, C₁-C₁₃ aryl, C₁-C₁₃ alkaryl, C₁-C₁₃ alkoxy, C₁-C₁₃ alkylarylalkyl, C₁-C₁₃ arylalkyl, C₁-C₁₃ alkylamidoalkyl or C₁-C₁₃ alkylaminoalkyl.

10. The functional fluid composition of claim 2 wherein the blend of dibasic esters comprises:
(i) from about 20-28%, by weight of the blend, a first dibasic ester of formula: 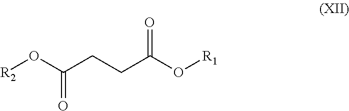
(ii) from about 59-67%, by weight of the blend, a second dibasic ester of formula: 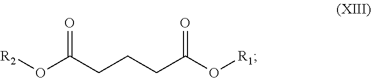
and
(iii) from about 9-17%, by weight of the blend, a third dibasic ester of formula: 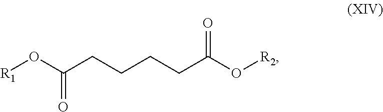
wherein R₁ and R₂ are hydrocarbon groups individually selected from C₁-C₁₃ alkyl, C₁-C₁₃ aryl, C₁-C₁₃ alkaryl, C₁-C₁₃ alkoxy, C₁-C₁₃ alkylarylalkyl, C₁-C₁₃ arylalkyl, C₁-C₁₃ alkylamidoalkyl or C₁-C₁₃ alkylaminoalkyl.

11. The functional fluid composition of claim 2 wherein the additive component is less than about 50% by weight of the functional fluid composition.

12. The functional fluid composition of claim 2 wherein the additive component is less than about 25% by weight of the functional fluid composition.

13. The functional fluid composition of claim 2 wherein the additive component is less than about 10% by weight of the functional fluid composition.

14. The functional fluid composition of claim 2 wherein the additive component is less than about 5% by weight of the functional fluid composition.

15. A method of increasing lubricity of a hydraulic fluid by contacting an effective amount of one or more blend of dibasic esters with the hydraulic fluid.

16. The method of claim 15 wherein the blend of dibasic esters is selected from the group consisting of dialkyl methylglutarate, dialkyl adipate, dialkyl ethylsuccinate, dialkyl succinate, dialkyl glutarate and any combination thereof.

17. The method of claim 15 wherein the blend of dibasic esters comprises (i) dialkyl methylglutarate and (ii) at least one of dialkyl adipate or dialkyl ethylsuccinate.

18. The method of claim 15 wherein the blend of dibasic esters comprises (i) dialkyl methylglutarate and (ii) dialkyl ethylsuccinate.

19. The method of claim 15 wherein the blend of dibasic esters comprises:
(i) from about 5-25%, by weight of the blend, a first dibasic ester of formula: 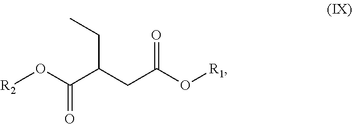
(ii) from about 70-95%, by weight of the blend, a second dibasic ester of formula: 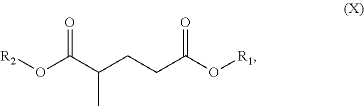
and
(iii) optionally, from about 0-5%, by weight of the blend, a third dibasic ester of formula: 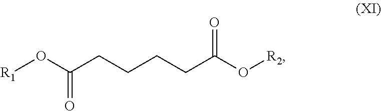
wherein R₁ and R₂ are hydrocarbon groups individually selected from C₁-C₁₃ alkyl, C₁-C₁₃ aryl, C₁-C₁₃ alkaryl, C₁-C₁₃ alkoxy, C₁-C₁₃ alkylarylalkyl, C₁-C₁₃ arylalkyl, C₁-C₁₃ alkylamidoalkyl or C₁-C₁₃ alkylaminoalkyl.

20. The method of claim 15 wherein the blend of dibasic esters comprises:
(i) from about 20-28%, by weight of the blend, a first dibasic ester of formula: 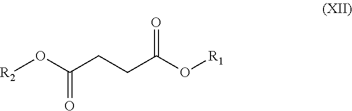
(ii) from about 59-67%, by weight of the blend, a second dibasic ester of formula: 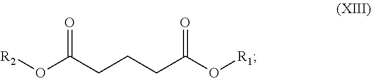
and
(iii) from about 9-17%, by weight of the blend, a third dibasic ester of formula: 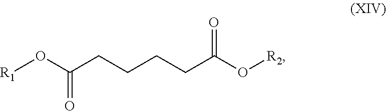
wherein R₁ and R₂ are hydrocarbon groups individually selected from C₁-C₁₃ alkyl, C₁-C₁₃ aryl, C₁-C₁₃ alkaryl, C₁-C₁₃ alkoxy, C₁-C₁₃ alkylarylalkyl, C₁-C₁₃ arylalkyl, C₁-C₁₃ alkylamidoalkyl or C₁-C₁₃ alkylaminoalkyl.
